(19) United States
(12) Patent Application Publication
(10) Pub. No.: US 2014/0369696 A1
(43) Pub. Date: Dec. 18, 2014

(54) Color Coding and Optical Sub-Band Communication Utilizing Color Coding

(71) Applicant: LSI Corporation, San Jose, CA (US)

(72) Inventor: Roger A. Fratti, Mohnton, PA (US)

(21) Appl. No.: 13/933,573

(22) Filed: Jul. 2, 2013

Related U.S. Application Data
(60) Provisional application No. 61/836,498, filed on Jun. 18, 2013.

(51) Int. Cl. H04B 10/116; H04B 10/69; H04B 10/50

(52) U.S. Cl. CPC H04B 10/116; H04B 10/502; H04B 10/69
USPC 398/172; 398/182; 398/202

(57) ABSTRACT

Data transmission method and apparatus utilizing color coding is disclosed. A one-to-one correspondence between a set of eight unique 3-bit data units and a set of eight unique color representations is established for color coding a sequence of 3-bit data units. Transmission of the sequence of 3-bit data units is then facilitated using a sequence of color representations, wherein each one of the sequence of 3-bit data units has a one-to-one correspondence with one of the sequence of color representations.

### CROSS-REFERENCE TO RELATED APPLICATIONS

The present application claims the benefit under 35 U.S.C. §119(e) of U.S. Provisional Application Ser. No. 61/836,498, filed Jun. 18, 2013. Said U.S. Provisional Application Ser. No. 61/836,498 is hereby incorporated by reference in its entirety.

### TECHNICAL FIELD

The present invention relates to the field of data communication and particularly to data communication using color coding.

### BACKGROUND

Data transmission or communication refers to the transfer of data (e.g., a digital bit stream) from one point to another. An alternative to sending digital information via electric voltage signals is to use optical signals.

### SUMMARY

Accordingly, an embodiment of the present disclosure is directed to a data transmission method. The data transmission method establishes a one-to-one correspondence between a set of eight unique 3-bit data units and a set of eight unique color representations. Transmission of a sequence of 3-bit data units is facilitated using a sequence of color representations, wherein each one of the sequence of 3-bit data units has a one-to-one correspondence with one of the sequence of color representations.

A further embodiment of the present disclosure is directed to a data stream transmission apparatus. The data stream transmission apparatus includes an encoder and a display device in communication with the encoder. The encoder is configured for encoding a data stream according to a color coding scheme, wherein the color coding scheme defines a one-to-one correspondence between a unique 3-bit data unit and a unique color representation, and wherein a sequence of 3-bit data units of the data stream is encoded into a sequence of color representations. The display device is configured for displaying the sequence of color representations to facilitate transmission of the data stream.

An additional embodiment of the present disclosure is directed to an apparatus for receiving a data stream. The apparatus includes an optical receiver and a decoder in communication with the optical receiver. The optical receiver is configured for optically receiving a sequence of colors. The decoder is configured for decoding the sequence of colors according to a color coding scheme, wherein the color coding scheme defines a one-to-one correspondence between a unique 3-bit data unit and a unique color, and wherein the sequence of colors is decoded into a sequence of 3-bit data units that forms the data stream.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration depicting a display device configured to facilitate data transmission utilizing a color coding scheme;

FIG. 2 is an illustration depicting another display device configured to facilitate data transmission utilizing a color coding scheme;

FIG. 3 is a block diagram depicting a communication system utilizing a color coding scheme for data transmission;

FIG. 4 is an illustration depicting a sequence of color being displayed; and

FIG. 5 is a flow diagram illustrating a method for facilitating data transmission.

### DETAILED DESCRIPTION

Reference will now be made in detail to the presently preferred embodiments of the invention, examples of which are illustrated in the accompanying drawings.

Display devices such as cathode ray tubes (CRTs), liquid-crystal displays (LCDs), light-emitting diodes (LEDs) and the like commonly use additive color systems to provide color. Additive color is color created by mixing light of two or more different colors. For instance, red, green, and blue are the additive primary colors normally used in an additive color system.

Embodiments of the present disclosure utilize various colors to carry various encoded data. In accordance with an embodiment of the present disclosure, the primary colors used in an additive color system and the combinations of such primary colors are utilized to represent various 3-bit data units. More specifically, suppose the additive color system uses red (R), green (G) and blue (B) as the primary colors, the following color coding scheme can be defined:

| 3-bit data | R | G | B | Color |
|---|---|---|---|---|
| 0 0 0 | 0 | 0 | 0 | Black |
| 0 0 1 | 0 | 0 | 1 | Blue |
| 0 1 0 | 0 | 1 | 0 | Green |
| 0 1 1 | 0 | 1 | 1 | Cyan |
| 1 0 0 | 1 | 0 | 0 | Red |
| 1 0 1 | 1 | 0 | 1 | Magenta |
| 1 1 0 | 1 | 1 | 0 | Yellow |
| 1 1 1 | 1 | 1 | 1 | White |

Wherein a one (1) in the RGB column above indicates that particular color is present in forming the color and a zero (0) in the RGB column indicates that particular color is no present.

Once a color coding scheme is defined, a display device can be utilized to facilitate data communication by displaying a sequence of colors. For example, suppose a data stream 001011100101111001 needs to be communicated. Utilizing the exemplary color coding scheme as defined above, a sequence of colors, namely: blue (001), cyan (011), red (100), magenta (101), white (111) and blue (001) can be displayed in this particular order to transmit the data stream.

It is contemplated that this sequence of colors being displayed can be detected by an optical receiver on the receiving side of the data communication. The optical receiver can be implemented using a camera, an imaging device or any optical sensor capable of detecting the various colors used by the color coding scheme. In one embodiment, the display device is configured to display the color representation of a 3-bit data unit for a specific duration of time immediately followed by the color representing the next 3-bit data unit for the same duration of time. This process continues until the entire data stream to be communicated has been represented sequentially. In this manner, the optical receiver is able to detect the same sequence of colors, namely: blue (001), cyan (011), red (100), magenta (101), white (111) and blue (001), and decode the sequence of colors to obtain the data stream as 001011100101111001 utilizing the same exemplary color coding scheme as defined above.

In one embodiment, the display device is configured to display a specific number of color representations (each representing a 3-bit data unit) per unit of time. For example, suppose the display device is configured to display 10 color representations per second, each color representation is therefore displayed for a tenth of a second. This predetermined number is referred to as a display frequency in the present disclosure, and such a display frequency is made available to the optical receiver, allowing the optical receiver to detect the displayed color according to the same frequency.

It is understood that the specific display frequency referenced above is merely exemplary. The actual display frequency implemented by the display device may vary based on specific applications as well as operating and/or environmental conditions. It is also contemplated that the display frequency may be modifiable or adjustable without departing from the spirit and scope of the present disclosure. Furthermore, spreading and other coding techniques can also be utilized to increase resistance to ambient light noise or the like.

It is also understood that the specific mapping between the 3-bit data units and their corresponding colors defined above is merely exemplary. Any color coding scheme that defines a one-to-one correspondence between a unique 3-bit data unit and a unique color can be utilized without departing from the spirit and scope of the present disclosure. In accordance with embodiments of the present disclosure, the three primary colors and the five combinations of these primary colors can be used to represent different 3-bit data units in various ways, as long as each unique color uniquely represents a 3-bit data unit.

More specifically, in additive color systems, the three primary colors and the five combinations of these primary colors (a total eight unique color representations) are provided as: 1) presence of a first primary color alone; 2) presence of a second primary color alone; 3) presence of a third primary color alone; 4) presence of the first primary color and the second primary color in equal proportions; 5) presence of the first primary color and the third primary color in equal proportions; 6) presence of the second primary color and the third primary color in equal proportions; 7) presence of the first primary color, the second primary color and the third primary color in equal proportions; or 8) presence of neither the first primary color, the second primary color nor the third primary color. It is contemplated that the color black (RGB value defined as 000 in the table above) is provide by a situation where all pixels are at a very low intensity or completely turned off.

Utilizing the primary colors and the combinations of these primary colors to represent data units can be implemented using existing display systems. For instance, LED billboards are becoming more common in public areas and are replacing static billboards. These LED billboards can be utilized to provide the infrastructure for data communication that can be used for various purposes. For example, a portion of the LED billboard can be used to transmit information to commuters passing through. The information transmitted can include emergency broadcast information, traffic information, school closing information, bridge closing, weather alerts or the like.

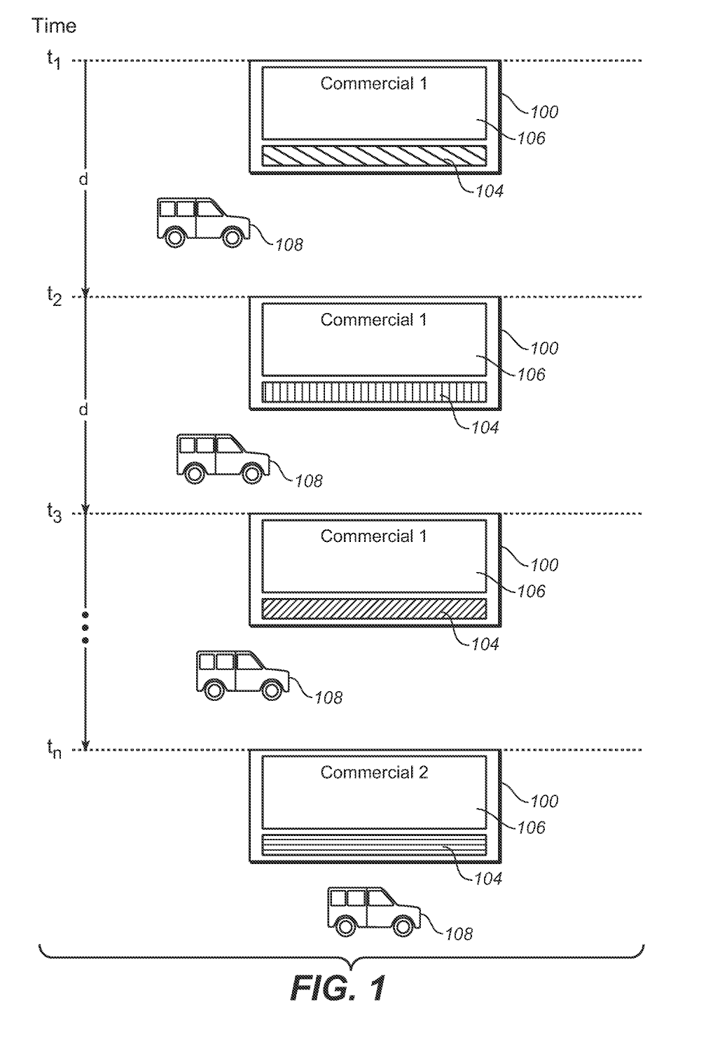

FIG. 1 is an illustration depicting a billboard 100 configured to facilitate data transmission to a vehicle 102 in accordance with one embodiment of the present disclosure. As shown in FIG. 1, a portion 104 of the billboard display 100 is utilized for displaying color representations of a data stream while the remaining portion 106 of the billboard display 100 is utilized for displaying contents such as commercials or other messages. It is contemplated that portion 104 of the billboard display 100 can be configured as a dedicated display portion for data transmission purposes. Alternatively, the billboard display 100 can be configured to logically separate portions 104 and 106 when needed. For instance, in a normal operating mode, portions 104 and 106 are configured to operate jointly as a single unit, and when switched to a data transmission mode, portions 104 and 106 are configured to operate independently and portion 104 can be utilized to facilitate data transmission.

More specifically, to facilitate data transmission utilizing a color coding scheme, portion 104 of the billboard display 100 is configured to display a sequence of color representations at a particular display frequency. For instance, as shown in FIG. 1, portion 104 of the billboard display 100 is configured to display a first color representation (representing the first 3-bit data unit) starting at time instance t1 for a specific duration d. Subsequently, starting at time instance t2, a second color representation (representing the next 3-bit data unit) is displayed for the same duration d. This process is continued until all data units in a given data stream have been represented. This process may then: 1) stop, 2) repeat recursively, or 3) repeat after a pause or display of an end-of-data indicator (e.g., a particular color pattern to indicate the end of data or the like).

It is contemplated that while portion 104 of the billboard display 100 is utilized to facilitate data transmission, the rest of the billboard display 100 still functions and can be utilized for other purpose. For instance, as shown in FIG. 1, the content displayed in portion 106 of the billboard display 100 can change at any time independently with respect to portion 104 of the billboard display 100. In this manner, the billboard display 100 allows the data stream to be transmitted without interfering with normal use of the billboard.

It is contemplated that a billboard display capable of facilitating data transmission can be used effectively to broadcast information to the general public. For instance, a billboard can broadcast traffic information and notify drivers of any road closures or accidents ahead. A camera, an imaging device or any optical sensor positioned in a vehicle 108 can be used as an optical receiver to receive the broadcasted information. More specifically, the optical receiver positioned in the vehicle 108 is able to detect the sequence of color representations and decode each color representation to obtain the data stream. It is contemplated that different actions may be taken in response to different information received without departing from the spirit and scope of the present disclosure.

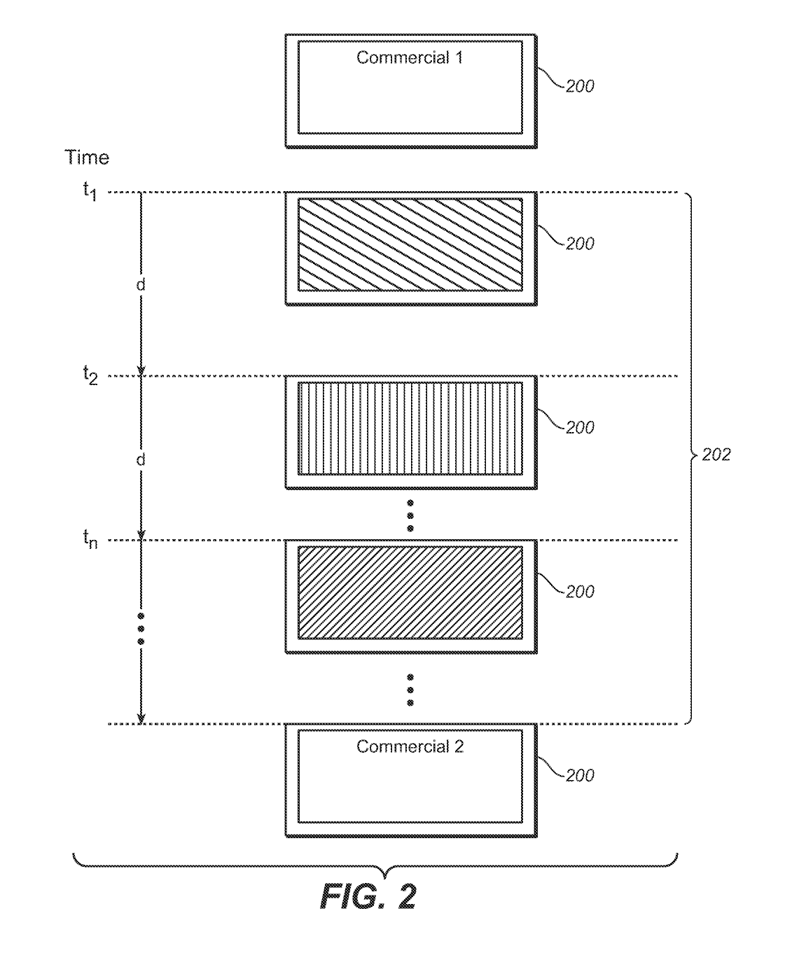

It is also contemplated that separating the billboard display 100 into two or more portions as shown in FIG. 1 to facilitate data transmission is merely exemplary. FIG. 2 is an illustration depicting a billboard 200 configured to facilitate data transmission in accordance with an alternative embodiment of the present disclosure. More specifically, a sequence of color representations can be displayed between normal operations of the billboard. For instance, if an emergency broadcast of an approaching storm is requested, commercial advertisements displayed on the billboard 200 can be withheld and the billboard display 200 can be configured to start broadcasting information regarding the storm using a sequence of colors 202. This process is continued and may be repeated until broadcasting of such information is no longer needed. Subsequently, the billboard display 200 can resume its normal operation and commercial advertisements are displayed again.

In another example, suppose the information to be broadcasted or transmitted is not time-critical, the billboard 200 has the option to choose an appropriate time to display the sequence of colors 202. For instance, if the billboard 200 switches between two or more different commercials, the billboard 200 has the option to display the sequence of colors 202 in between any two commercials to minimize potential interruptions. It is contemplated, however, that a billboard display may utilize other operating modes to facilitate data transmission without departing from the spirit and scope of the present disclosure.

While the examples above depicted billboards as means for facilitating data transmissions, it is contemplated that various other types of display devices can also be utilized without departing from the spirit and scope of the present disclosure. It is also contemplated that the optical receivers configured for detecting and receiving such data transmissions can be associated with other types of devices in addition to vehicles referenced above. For instance, mobile phones equipped with cameras can be utilized to receive and process the data being transmitted.

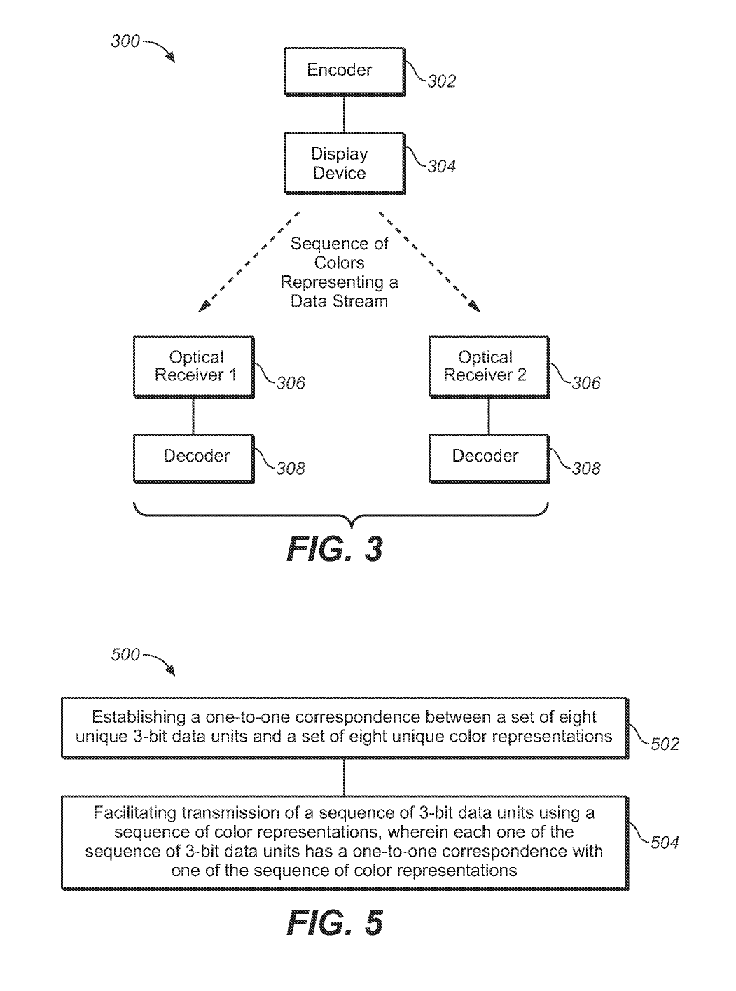

FIG. 3 is a block diagram depicting a communication system 300 utilizing a color coding scheme for data transmission in accordance with embodiments of the present disclosure. As illustrated in the figure, an encoder 302 is utilized to sequentially encode each 3-bit data unit of a given data stream based on a defined color coding scheme. The encoder 304 is communicatively coupled to one or more display devices 304. Each display device 304 is utilized to display the sequence of colors representing the data stream. The sequence of colors being displayed can be detected and received by one or more optical receivers 306. A decoder 308 communicatively coupled to an optical receiver 306 is then utilized to decode the sequence of colors received based on the color coding scheme in order to obtain the data stream.

It is contemplated that the encoder 302 and/or decoder 308 referenced above can be implemented as either a stand-alone or an integrated component of the display devices 304 and/or optical receivers 306, respectively. In one embodiment, each encoder 302 and/or decoder 308 utilizes a computer processor in communication with a computer-readable device having computer-executable instructions for performing the encoding/decoding process as described above.

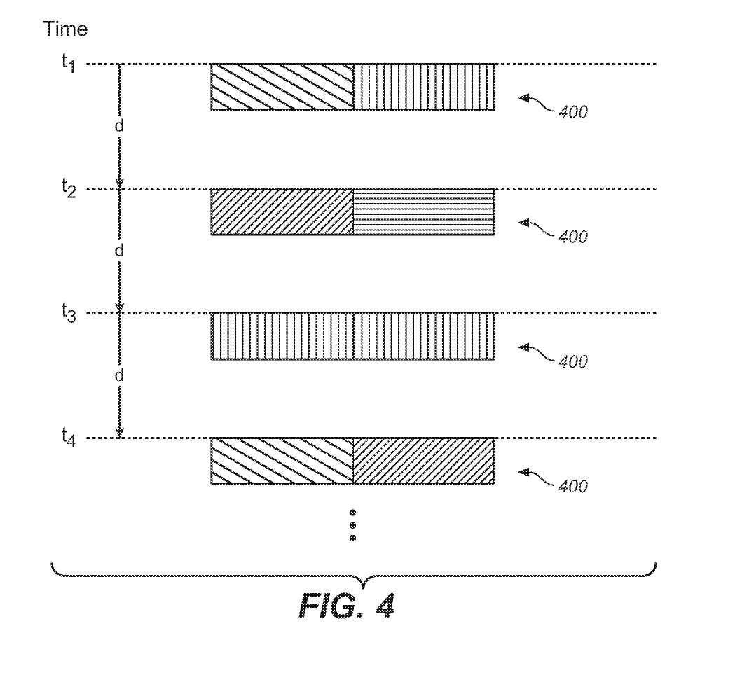

Furthermore, it is contemplated that a display device configured to facilitate data transmission in accordance with embodiments of the present disclosure is not limited to displaying a single color representation at a time. Referring to FIG. 4, a simplified illustration depicting a sequence of color being displayed is shown, wherein element 400 represents the portion of a display device configured for displaying color representations of a data stream. As shown in the figure, two color representations are being displayed simultaneously, allowing the optical receiver to read two color representations representing 6 bits of the data stream at the same time.

It is noted that while two color representations are being displayed, it does not imply that the two color representations have to be of different colors. Each color is determined based on the 3-bit data unit it represents. Therefore, if the data stream happens to have two identical 3-bit data units adjacent to each other, the two color representations being displayed should also be identical. It is the function of the optical receiver to recognize that it is reading two color representations and decode the two color representations accordingly.

It is contemplated that the number of color representations that can be displayed simultaneously is not limited to two. It is noted that at the same display frequency, increasing the number of color representations simultaneously displayed increases data rate but may also increase error rate. Therefore, the specific number of color representations displayed simultaneously can be determined based on specific applications as well as operating and/or environmental conditions, and may differ without departing from the spirit and scope of the present disclosure.

FIG. 5 is a flow diagram illustrating a method 500 for facilitating data transmission. Step 502 establishes a color coding scheme. In accordance with embodiments of the present disclosure, the color coding scheme is established as a one-to-one correspondence between a set of eight unique 3-bit data units and a set of eight unique color representations. More specifically, the set of eight unique color representations corresponds to eight unique combinations of three primary colors, which include: 1) presence of a first primary color alone; 2) presence of a second primary color alone; 3) presence of a third primary color alone; 4) presence of the first primary color and the second primary color in equal proportions; 5) presence of the first primary color and the third primary color in equal proportions; 6) presence of the second primary color and the third primary color in equal proportions; 7) presence of the first primary color, the second primary color and the third primary color in equal proportions; and 8) presence of neither the first primary color, the second primary color nor the third primary color.

Once the color coding scheme is established, step 504 can facilitate transmission of any given sequence of 3-bit data units using a sequence of color representations. Since the color coding scheme establishes a one-to-one correspondence between the 3-bit data units and the color representations, each 3-bit data unit from the sequence of 3-bit data units has a one-to-one color representation. This allows the data transmission method 500 to send or receive data streams using sequences of color representations.

For instance, to send a given data stream, a sequence of color representations that represents the given data stream can be displayed on one or more display devices. The sequence of color representations being displayed can be optically detected and received on the receiving side by an optical receiver. The received sequence of color representations can then be decoded based on the color coding scheme to obtain the data stream.

It is to be understood that the present disclosure may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A data transmission method, comprising:
establishing a one-to-one correspondence between a set of eight unique 3-bit data units and a set of eight unique color representations; and
facilitating transmission of a sequence of 3-bit data units using a sequence of color representations, wherein each one of the sequence of 3-bit data units has a one-to-one correspondence with one of the sequence of color representations.

2. The method of claim 1, wherein the set of eight unique color representations corresponds to eight unique combinations of three primary colors.

3. The method of claim 2, wherein the eight unique combinations of three primary colors include:
presence of a first primary color alone;
presence of a second primary color alone;
presence of a third primary color alone;
presence of the first primary color and the second primary color in equal proportions;
presence of the first primary color and the third primary color in equal proportions;
presence of the second primary color and the third primary color in equal proportions;
presence of the first primary color, the second primary color and the third primary color in equal proportions; and
presence of neither the first primary color, the second primary color nor the third primary color.

4. The method of claim 1, wherein facilitating transmission of the sequence of 3-bit data units includes:
displaying the sequence of color representations utilizing at least one display device.

5. The method of claim 4, wherein the display device is configured for sequentially displaying each one of the sequence of color representations at a time.

6. The method of claim 4, wherein the display device is configured for sequentially displaying a plurality of consecutive color representations from the sequence of color representations at a time.

7. The method of claim 1, wherein facilitating transmission of the sequence of 3-bit data units includes:
optically detecting and receiving the sequence of color representations utilizing an optical receiver; and
decoding the sequence of color representations to obtain the sequence of 3-bit data units according to the established one-to-one correspondence between the data units and the color representations.

8. A data stream transmission apparatus, comprising:
an encoder configured for encoding a data stream according to a color coding scheme, wherein the color coding scheme defines a one-to-one correspondence between a unique 3-bit data unit and a unique color representation, and wherein a sequence of 3-bit data units of the data stream is encoded into a sequence of color representations; and
a display device in communication with the encoder, the display device configured for displaying the sequence of color representations to facilitate transmission of the data stream.

9. The apparatus of claim 8, wherein the color coding scheme defines a one-to-one correspondence between a set of eight unique 3-bit data units and a set of eight unique color representations.

10. The apparatus of claim 9, wherein the set of eight unique color representations corresponds to eight unique combinations of three primary colors.

11. The apparatus of claim 10, wherein the eight unique combinations of three primary colors include:
presence of a first primary color alone;
presence of a second primary color alone;
presence of a third primary color alone;
presence of the first primary color and the second primary color in equal proportions;
presence of the first primary color and the third primary color in equal proportions;
presence of the second primary color and the third primary color in equal proportions;
presence of the first primary color, the second primary color and the third primary color in equal proportions; and
presence of neither the first primary color, the second primary color nor the third primary color.

12. The apparatus of claim 8, wherein the display device is configured for displaying the sequence of color representations within a portion of a display area while at least one other portion of the display area is independently operable.

13. The apparatus of claim 8, wherein the display device is configured for sequentially displaying each one of the sequence of color representations at a time.

14. The apparatus of claim 8, wherein the display device is configured for sequentially displaying a plurality of consecutive color representations from the sequence of color representations at a time.

15. The apparatus of claim 8, wherein the display device is an electronic billboard configured for broadcasting the data stream.

16. An apparatus for receiving a data stream, the apparatus comprising:
an optical receiver configured for optically receiving a sequence of colors; and
a decoder in communication with the optical receiver, the decoder configured for decoding the sequence of colors according to a color coding scheme, wherein the color coding scheme defines a one-to-one correspondence between a unique 3-bit data unit and a unique color, and wherein the sequence of colors is decoded into a sequence of 3-bit data units that forms the data stream.

17. The apparatus of claim 16, wherein the color coding scheme defines a one-to-one correspondence between a set of eight unique 3-bit data units and a set of eight unique color representations.

18. The apparatus of claim 17, wherein the set of eight unique color representations corresponds to eight unique combinations of three primary colors.

19. The apparatus of claim 18, wherein the eight unique combinations of three primary colors include:
presence of a first primary color alone;
presence of a second primary color alone;
presence of a third primary color alone;
presence of the first primary color and the second primary color in equal proportions;
presence of the first primary color and the third primary color in equal proportions;
presence of the second primary color and the third primary color in equal proportions;
presence of the first primary color, the second primary color and the third primary color in equal proportions; and
presence of neither the first primary color, the second primary color nor the third primary color.

20. The apparatus of claim 16, wherein the optical receiver is configured for detecting and receiving the sequence of colors being displayed on an electronic display device.
